(19) United States
(12) Patent Application Publication
(10) Pub. No.: US 2025/0135644 A1
(43) Pub. Date: May 1, 2025

(54) METHOD FOR CONTROLLING A CONSTRUCTION ROBOT AND CONSTRUCTION ROBOT

(71) Applicant: Hilti Aktiengesellschaft, Schaan (LI)

(72) Inventors: Peter BRUGGER, Feldkirch (AT); Julia ZANONA, Feldkirch (AT); Stein M. NORNES, Sogndal (NO); Eirik STRAND, Sogndal (NO)

(21) Appl. No.: 18/690,915

(22) PCT Filed: Oct. 17, 2022
(86) PCT No.: PCT/EP2022/078795

§ 371 Date: Mar. 11, 2024

(30) Foreign Application Priority Data
Oct. 29, 2021 (EP) 21205451.4

(51) Int. Cl. B25J 9/16

(52) U.S. Cl. CPC B25J 9/1666

(57) ABSTRACT

A method for controlling a construction robot which has a manipulator and wherein the manipulator has an end effector is disclosed, wherein the end effector is moved from a starting position to a working position, wherein an obstacle is identified, and the identified obstacle is bypassed. A construction robot is also disclosed.

The invention is based on a method for controlling a construction robot which has a manipulator and wherein the manipulator has an end effector, wherein the end effector is moved from a starting position to a working position.

To allow the highest possible degree of autonomy of a construction robot, it is desirable if the construction robot moves its end effector as safely as possible from a starting position on a construction site to a working position on the construction site, so that a construction task can be performed with the end effector at the working position.

The object of the present invention is therefore to offer a method for controlling a construction robot and a construction robot that allow an end effector of the construction robot to be moved safely from a starting position to a working position.

The object is achieved by a method for controlling a construction robot which has a manipulator and wherein the manipulator has an end effector, wherein the end effector is moved from a starting position to a working position. When it does so, any obstacle is identified. The obstacle may be for example between the starting position and the working position. It may be that the working position cannot be reached from the starting position by a translational movement of the end effector in a straight line. For example, an obstacle may be on a straight line connecting the working position and the starting position. The obstacle may be arranged and/or formed in such a way that there would be a collision between the manipulator and/or the end effector and the obstacle if the end effector were moved in a straight line. The collision may also correspond to contact with the obstacle. It is also conceivable that the working position can only be reached in the first place in a specific relative position of the construction robot, the manipulator and/or the end effector.

The working position may be for example on a ceiling, on a wall and/or on a floor.

The obstacle may be and/or comprise an unevenness in a surface. The obstacle may be in particular in the vicinity of the starting position and/or the working position. Such unevennesses occur for example in the case of corrugated sheet, in the case of a ceiling having one or more steps and/or in the case of a ceiling, a wall and/or a floor from which a structural element protrudes. The structural element and/or the obstacle may be for example a line, a pipe, a cable, a bearing element, an installation element and/or the like.

The end effector may have at least one tool, for example, a drilling tool, a cutting tool, a setting tool, in particular for setting an anchor, a chiseling tool and/or the like. Moving the end effector from a starting position to a working position may then be understood as meaning that the tool, in particular a tool tip of the tool, is moved from the starting position to the end position.

The obstacle may be identified by means of an investigation of a working area of the construction robot 10.

Alternatively or additionally, the obstacle may be identified by analysis of planning data, for example from BIM (Building Information Model) data.

The method also provides that the identified obstacle is bypassed. In this way, a collision with the obstacle can be avoided. Bypassing an obstacle may be understood for example as meaning that the end effector passes from one side of the obstacle to another side of the end effector without a collision. This may alternatively or additionally be understood as meaning that the end effector is moved along the obstacle without a collision.

To bypass the obstacle, at least one movement scheme may be realized. The movement scheme may be predefined and/or predefinable. It may be performed repeatedly. The movement scheme may reduce an amount of planning effort involved in planning a movement path for bypassing the obstacle. In this way, for example, computing time of a computer can be saved. The working position can be reached more quickly from the starting position. The movement scheme may be based on at least one special feature of a typical construction site. The movement scheme may form part of an overall movement sequence for moving the end effector from the starting position to the working position.

The movement scheme may comprise a sequence of partial movements of the construction robot, in particular its manipulator and/or its end effector. A partial movement may comprise at least one translational movement and/or rotational movement of at least one element of the construction robot, in particular its manipulator and/or its end effector. A partial movement may also be variable with respect to its extent. For example, a movement scheme may also comprise multiple variants, in which one or more partial movements are in each case provided in the same sequence, but differ in their extent, for example in the case of a translational movement in the length of the translation or in the case of a rotational movement in the angle of rotation. The movement scheme may consequently correspond to a heuristic for controlling the movement of the construction robot.

The movement scheme may correspond to a U-shaped or substantially U-shaped movement.

For example, the movement scheme may comprise a perpendicular or substantially perpendicular removal of the end effector from the starting position, a once again perpendicular or substantially perpendicular movement of the end effector in relation thereto and subsequently a perpendicular or substantially perpendicular approach of the end effector to the working position.

The length of the removal and/or approach may be at least 0.3 m, 0.8 m or 1 m.

It may be envisaged to determine the necessary length of the removal and/or the approach on the basis of BIM data. For example, with respect to installation elements suspended from a ceiling, the maximum height below which there are no longer any installation elements may be determined.

In this case, “substantially” may correspond to a deviation of for example +/−10°. In particular, it may correspond to a deviation of up to +/−5°. “Substantially perpendicular” may consequently correspond for example to an angle between 80 and 100°, in particular between 85° and 95°. Indications of an angle, such as for example “perpendicularly”, may relate in each case to an angle measured in relation to a tangential plane through the respective reference point, in particular the starting position or the working position.

If for example the starting position and the working position are on a ceiling, the movement scheme may comprise first a vertical or at least substantially vertical movement of the end effector downward, a subsequent horizontal or at least substantially horizontal displacement of the end effector and subsequently a vertical or at least substantially vertical movement of the end effector upward.

Such a U-shaped or substantially U-shaped movement scheme can often be successfully used on construction sites. This is so because approaching a working position in a straight line or in a perpendicular or at least substantially perpendicular direction is often possible without a collision.

If for example the end effector is at a starting position on a ceiling and is intended to move to a working position on the same ceiling, there are often obstacles between the starting position and the working position. These obstacles may be for example suspended pipes, bearing elements or the like. Since such elements are only arranged to a certain height below the ceiling, for example to at most 0.3 m, at most, 0.8 m or at most 1 m below the ceiling, the end effector may initially be lowered perpendicularly or substantially perpendicularly from the ceiling to below this height.

Then it can be assumed with sufficient certainty that there are no longer any pipes or the like at the height to which it has moved. Consequently, the end effector can subsequently be moved horizontally or substantially horizontally sideways.

In particular, the end effector can be moved until it is perpendicularly or at least substantially perpendicularly below the working position. Then, the end effector can be moved upward, in particular perpendicularly or at least substantially perpendicularly upward, until it reaches the working position. The U-shaped or substantially U-shaped movement scheme may consequently be a heuristic designed specifically for construction sites, or comprise such a heuristic.

It is in this way possible in the case of typical construction sites to bypass the obstacle without first investigating a surrounding area.

Alternatively or additionally, it is also conceivable that the movement scheme comprises a side-changing movement.

Customary manipulators have restricted movement capabilities. The manipulator may for example be formed as a multilink arm. It may have three or more degrees of freedom, preferably at least six degrees of freedom. Specific working positions may then be approached for example in such a way that specific parts of the manipulator are arranged in a hemisphere of the construction robot. By means of the side-changing movement, these elements of the manipulator can for example be brought into the opposite hemisphere.

The end effector may have a tool. The tool may be moved to the working position in a working direction. In this case, the end effector may be aligned in such a way that the tool is moved by a distance of less than half the length of a longest diameter of the end effector, measured along a plane perpendicular to the working direction. Preferably, the end effector is moved at a distance of at most half the length of the shortest diameter, measured in the same plane. For this purpose, the end effector and/or the manipulator may be rotated.

One idea in this respect is that, if for example the end effector is not formed rotationally symmetrically and/or the tool is not arranged as centered within the end effector, there are specific positions and/or locations of the end effector such that the tool can come closer to the obstacle than in the case of other positions and/or locations. Consequently, working positions that cannot otherwise be reached, in particular because otherwise parts of the manipulator and/or the end effector would collide with the obstacle, can be approached.

It is also conceivable that, while moving to the working position, the manipulator is moved past the obstacle. It is consequently conceivable that not only is a collision of the end effector and/or the tool with the obstacle avoided, but also the rest of the manipulator does not collide with the obstacle.

For this purpose, the movement planning may take into account the shape, in particular, the dimensions, of the end effector and/or the tool. It may also take into account the shape and/or mechanical properties of the manipulator. Thus, it may for example be planned over which routes different elements of the manipulator move while the end effector is being moved from the starting position to the working position.

It is generally also conceivable that the movement planning also takes into account further elements of the construction robot. In particular, it is conceivable to include at least most, in particular all, of the available degrees of freedom of the construction robot in the movement planning. Thus, in order to move the end effector from the starting position to the end position, it is conceivable not only to control the manipulator together with the end effector, but for example also to control a mobile platform of the construction robot.

In the case of one exemplary embodiment, the obstacle may be identified by planning data being analyzed. Alternatively or additionally, it is conceivable that the obstacle is identified by a working area being optically scanned by a range meter. The range meter may be a laser scanner. Alternatively or additionally, it may also be formed as a 3D camera and/or comprise such a camera.

The range meter may be moved during the optical scanning. In particular, it may be moved continuously. Alternatively or additionally, it may also be moved intermittently. The range meter may also be moved together with at least one other element of the construction robot. For example, for the precise positional determination of the construction robot, a position detection device, for example a prism, may be moved along a specific path. If the range meter and the position detection device are moved jointly, the range meter may also be moved during the movement of the position detection device. In this way, multiple measurements of the range meter, for example multiple 3D recordings, can be combined to form a more comprehensive overall measurement, for example a larger overall 3D recording.

It is also conceivable that, by moving the range meter, at least one additional perspective can be included by the range meter. In this way, shadings or the like can also be reduced or avoided. Elements that are otherwise concealed can be investigated. This also allows the detection of multiple obstacles that would not be detectable without movement of the range meter.

The end effector may be moved to at least two working positions one after the other. In other words, a first working position may serve as a starting position for a movement to a second working position. It is thus conceivable for example that the end effector is moved to at least two working positions one after the other in the same hemisphere of a working area of the construction robot, in particular the manipulator.

If consequently multiple working positions are available, it is thus possible on the basis of a first working position to select a second working position that is as close as possible to the first working position and can be reached as quickly as possible and/or over a shortest possible route. This can exploit the fact that working positions in the same hemisphere of the construction robot can usually be approached more quickly one after the other than if two working positions are in different hemispheres of the construction robot.

It is conceivable in particular that first all working positions in a first hemisphere are approached one after the other. Subsequently, one or more, in particular all, of the working positions in the other hemisphere of the working area can be approached one after the other. For changing the hemispheres, a side-changing movement may be performed.

The overall working time for reaching all of the working positions can also be minimized by selecting on the basis of one working position as a starting position a subsequent working position such that the subsequent working position can be reached from the starting position without bypassing an obstacle. In this way, all “easily” reachable working positions can first be dealt with one after the other. Then the working positions that are “more difficultly” reachable can be approached one after the other.

The movement planning may be performed by an optimization under boundary conditions and/or constraints. A constraint in this respect may be that the number of changes of the hemispheres and/or the use of movement schemes, for example a side-changing movement, is minimized.

Alternatively or additionally, the use of a neural network is also conceivable. A training of the neural network may be performed on the basis of BIM data. It is also conceivable that, for the training, training data are simulated before and/or during the training.

The scope of the invention also covers a construction robot, comprising a manipulator with an end effector and a controller. The controller is set up to control the construction robot according to the previously described method.

The construction robot may be formed for performing construction work on a building construction site and or a civil engineering construction site. It may be set up for performing construction work on a ceiling, a wall and/or a floor. In may be formed for drilling, cutting, chiseling, grinding and/or setting a structural element It may have one or more power tools. In particular, the power tool may be exchangeably arranged and/or formed. The power tool may be an electrical power tool. The power tool may have a tool.

The end effector may comprise the power tool and/or the tool. For example, the end effector may have an electrical power tool. The electrical power tool may comprise a construction tool, a cutting tool, a grinding tool and/or a setting tool. It is also conceivable that the end effector and/or the power tool are formed for marking. For example, the end effector may have a paint spraying device.

The manipulator may be formed as a robot arm. The manipulator may also have a lifting device. The lifting device may increase the size of the overall volume that can be reached by the manipulator. The manipulator may have at least three degrees of freedom. In particular, it may have at least six degrees of freedom.

The construction robot may also have a mobile platform. The mobile platform may comprise a wheeled undercarriage and/or a track-chain undercarriage. The mobile platform may have at least two degrees of freedom. The construction robot may have altogether at least ten degrees of freedom.

The construction robot may have a range meter. The range meter may be formed as a 3D camera and/or comprise such a camera Alternatively or additionally, it may comprise a laser scanner.

The controller may be formed as a computer unit. It may have a processor, a memory unit and/or a program code that can be executed by the processor. The processor may have one or more sub-processors. The program code may be set up to perform the method for controlling the construction robot by the controller.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combinations in variants of the invention.

Exemplary embodiments of the invention are shown in the schematic drawing and explained in more detail in the following description.

### IN THE DRAWING

FIG. 1 shows a perspective representation of a construction robot;

FIGS. 2A and 2B show a schematic, perspective representation of a construction robot investigating a working area and a photographic recording of the working area;

FIG. 3 shows a schematic, perspective representation of the result of the investigation of the working area according to FIG. 2B;

FIG. 4 shows a perspective representation of a construction robot, which moves its end effector to a working position close to an obstacle;

FIG. 5 shows a schematic representation of the construction robot according to FIG. 4 in a view from above;

FIG. 6 shows a perspective representation of a construction robot which performs with its end effector a movement according to a U-shaped movement scheme;

FIGS. 7A and 7B show schematic representations of a starting position and an end position of a construction robot before and after a side-changing movement;

FIG. 8A to 8F show photographic representations of the sequence of a side-changing movement of a construction robot; and

FIG. 9A to 9F show schematic perspective representations of a sequence of bypassing an obstacle by an end effector

In order to make it easier to understand the invention, the same reference signs are used in each case for identical or functionally corresponding elements in the following description of the figures.

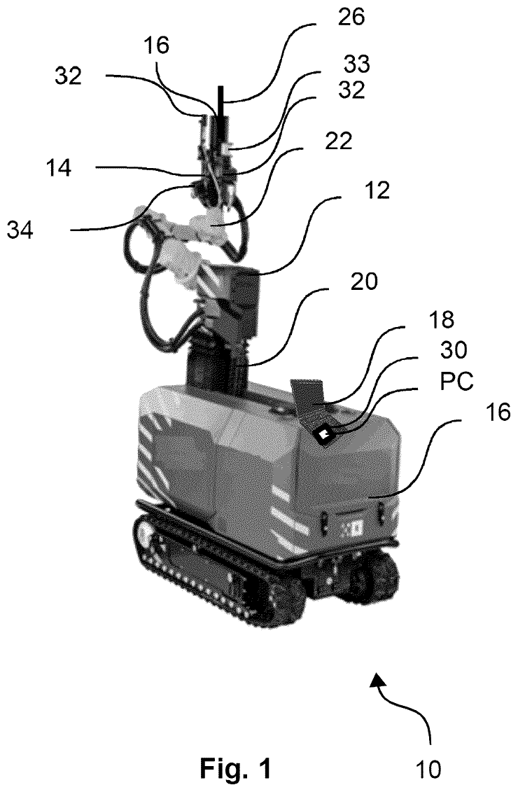

FIG. 1 shows a construction robot 10. The construction robot 10 has a manipulator 12 with an end effector 14. The construction robot 10 also has a mobile platform 16, which in this exemplary embodiment has a track-chain undercarriage.

The construction robot 10 also has a controller 18, which in FIG. 1 is only schematically depicted.

The manipulator 12 has a lifting device 20 and an arm 22. The arm 22 is multiaxial. In particular, it has six degrees of freedom. The lifting device 20 allows the arm 22 to be adjusted in the vertical direction, so that the range of the arm 22, and with it a working area of the manipulator 12, is extended in the vertical direction.

The end effector 14 has an electrical power tool 24. In this exemplary embodiment, the electrical power tool 24 is formed as a hammer drill, in particular an electropneumatic hammer drill. The electrical power tool 24 also has a tool 26, in this exemplary embodiment a drill.

The controller 18 has a computer 30, which in FIG. 1 is only schematically represented. The computer 30 has a processor, at least one memory unit, a program code PC that can be executed on the processor and a communication interface. The program code PC is set up to control the construction robot 10 on the basis of the method explained above and below. The communication interface may comprise a keyboard and/or a position input device. The communication interface is set up for acoustic data output. It may also be set up for acoustic data input. For this purpose, it may comprise a voice recognition logic.

The construction robot 10 is formed as a drilling construction robot. In particular, it is set up to drill into ceilings and/or walls. In the case of an alternative embodiment, the construction robot 10 has a tool-changing device. It enables it in any embodiment to change the electrical power tool 24 and/or the tool 26. For example, it may be set up by means of the tool-changing device to use a setting tool for setting anchors. It is also conceivable that the construction robot 10 has more than one tool, more than one machine tool 24 and/or other types of tools 26 and/or machine tools 24. In particular, a paint spraying device 32 is arranged on the end effector 14. The paint spraying device 32 is set up to spray paint markings onto a substrate, for example a ceiling, a wall or a floor, as desired.

Also arranged on the end effector 14 is a prism 33. The prism 33, and with it the end effector 14, can, for example, be located by means of a total station, in particular an automatic total station (not shown in FIG. 1).

Also arranged on the end effector 14 is a 3D camera 34. The 3D camera 34 is set up to record three-dimensional recordings of a working area of the construction robot 10. The recordings in this case also comprise depth information. For this purpose, the 3D camera 34 is set up to measure a multiplicity of distances. By means of the 3D camera 34, consequently the construction robot 10 can optically scan at least certain regions of a working area surrounding it.

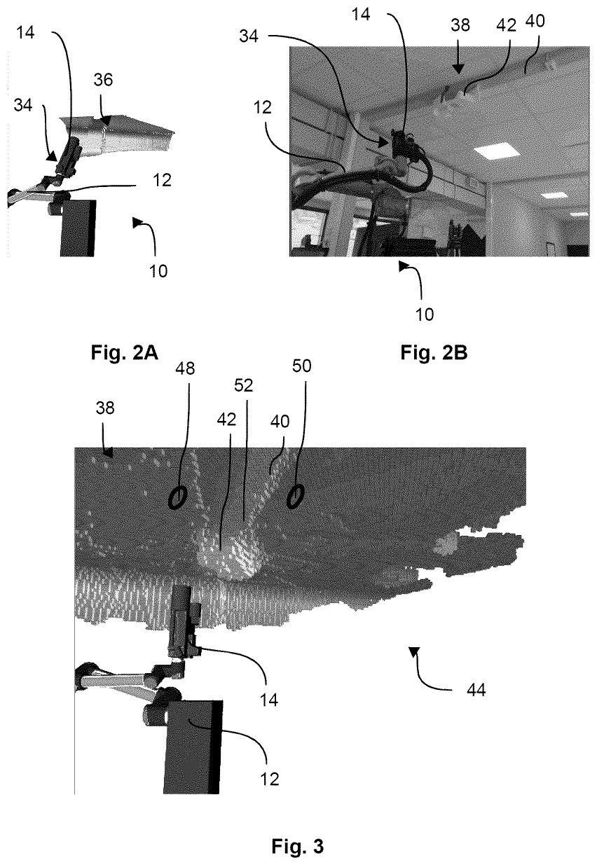

FIG. 2A shows in a schematic, perspective representation the construction robot 10 with the manipulator 12, the end effector 14 and the 3D camera 34. Dependent on the respective positions and locations of the end effector 14 and the manipulator 12, the camera 34 records a recording 36 of a working area 38 of the construction robot 10 in a way corresponding to its field of view. The working area 38 may correspond to an area surrounding the construction robot 10.

FIG. 2B shows the working area 38, from which the recording 36 according to FIG. 2A originates, in a photographic representation. A cable duct 40, which is arranged under a ceiling and on the underside of which a further object 42 is arranged, can be seen in particular.

By moving the manipulator 12 and/or the end effector 14, and with it the 3D camera 34, multiple recordings 36 (FIG. 2A) of the working area 38 can be recorded, in particular from different positions and/or locations.

During the recordings, in each case the positions and locations of the 3D camera 34 are also logged for each of the recordings 36. The positions and locations may in this case be determined by means of the prism 33 and for example the total station.

In the case of an exemplary embodiment, the individual recordings 36 are projected into a fixed coordinate system, in each case in a way corresponding to the logged positions and locations, and for this purpose are rectified in a way corresponding to the respective projection. On the basis of the fixed coordinate system, the multiple recordings 36 can in this way be combined to form an overall recording.

FIG. 3 shows in a schematic, perspective representation an example of such an overall recording 44 of the working area 38, as can be obtained from a combination of the multiple recordings 36. For better illustration, the manipulator 12 with the end effector 14 is additionally depicted in FIG. 3.

The overall recording 44 consequently has a three-dimensional point cloud of measuring points of the recordings 36 In the case of a further embodiment, this three-dimensional point cloud may be subjected to further image processing. In particular, intermediate points and/or surface profiles may be interpolated and/or extrapolated.

The overall recording 44 shows an unevenness 46. The unevenness 46 corresponds in this case to the cable duct 40 with a further object 42.

In FIG. 3, a starting position 48, which may for example correspond to a first working position, and a, in particular second, working position 50 are also schematically marked on respectively opposite sides of the cable duct 40 or the object 42.

On account of the cable duct 40 and the object 42, the end effector 14 cannot be moved in a straight line from the starting position 48 to the working position 50. Consequently, the cable duct 40 and the object 42 form an obstacle 52.

In order consequently to arrive at the working position 50 from the first working position or the starting position 48, the construction robot 10 with its manipulator 12 and its end effector 14 bypasses the obstacle 52.

In the case of this exemplary embodiment, the obstacle 52 has been detected by investigation, in particular by optical scanning, of the working area 38. In particular, in the case of this exemplary embodiment, a detection of the obstacle 52 took place by means of the 3D camera 34.

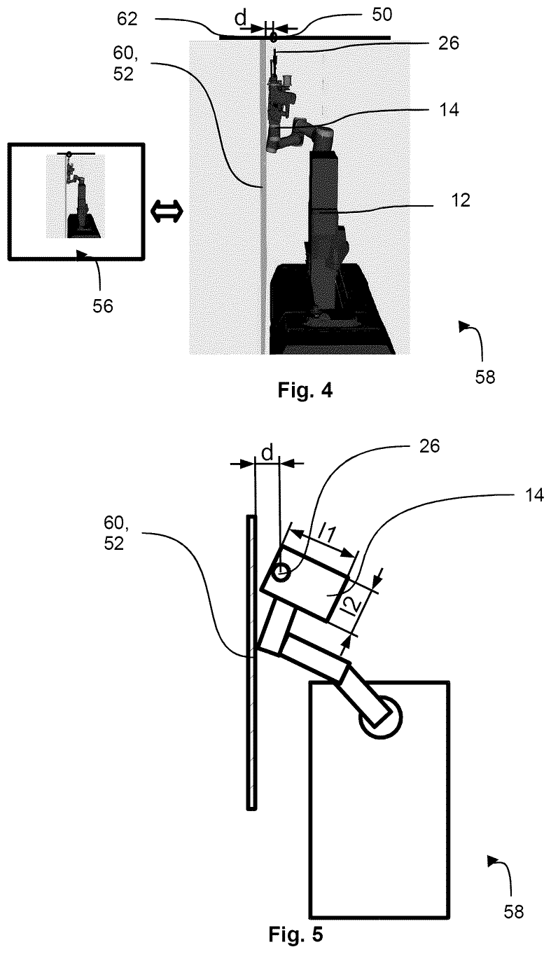

In the case of a further exemplary embodiment, as depicted in FIG. 4 and FIG. 5, BIM data 56—symbolically depicted in FIG. 4—of a construction site 58, schematically illustrated in FIG. 4, are available. The BIM data 56 may for example take the form of CAD data. In particular, a wall 60 and a ceiling 62 and their respective shapes, positions and locations are known from the BIM data 58.

According to the BIM data 56, a working position 50 to be reached is on the ceiling 62. The working position 50 is at a small distance from the wall 60. Due to its proximity, the wall 60 consequently hinders access to the working position 50 on the ceiling 62. The wall 60 consequently forms an obstacle 52.

In the case of this exemplary embodiment, the wall 60, and with it the obstacle 52, can consequently be detected by analysis of the BIM data 56. In particular, it can be determined by analysis of the BIM data 56 that the wall 60 forms an obstacle 52 for reaching the working position 50.

In order in this way to be able to move the end effector 14 with its tool 26 to the working position 56, the manipulator 12 and the end effector 14 are aligned in such a way that the tool 26 is guided along close to the obstacle 52, in particular without a collision.

FIG. 5 shows in this respect in a schematic representation the situation according to FIG. 4 in a schematic view from above.

It can be seen that the end effector 14 schematically represented in FIG. 5 with the tool 26 has a longest diameter I1 and a shortest diameter I2.

The tool 26 is arranged non-centrally on the end effector 14. It is in particular in an edge region of the end effector 14.

Depending on the relative situation and position of the end effector 14 in relation to the obstacle 52, consequently working positions that are more or less close to the obstacle 52 can be approached.

In this situation according to FIGS. 4 and 5, the end effector 14 is arranged in such a way that the tool 26 is at the distance d away from the obstacle 52. In this case, the distance d is less than half the length of the longest diameter I1.

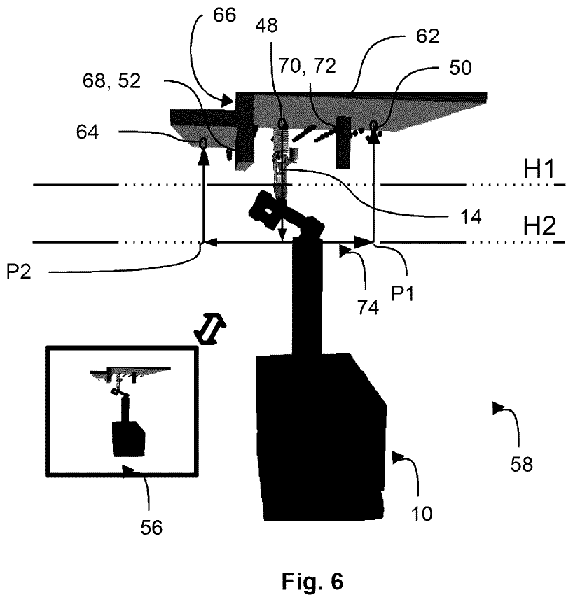

FIG. 6 then shows a further construction site 58. In the situation shown, the end effector 14 of the construction robot 10 is moved from a starting position 48 to a working position 50. Subsequently, it may be moved to further working positions, for example a working position 64.

The starting position 48 may in this case likewise be a working position, for example at which construction work, for example drilling of a hole, has already been performed.

The working positions 50, 64 are once again on a ceiling 62. The ceiling 62 has a step 66. On the ceiling there are two installation elements 68 and 70. The installation elements 68, 70 protrude downward from the ceiling 62. They consequently form obstacles 52, 72.

Shapes, positions and locations of the obstacles 52, 72 are detected by analysis of BIM data 56 of the construction site 58. Alternatively or additionally, here too it is conceivable to detect the obstacles 52, 72 by analyzing, in particular optically scanning, a working area, as described for example in conjunction with FIGS. 2A, 2B and 3.

It is deduced from the BIM data 56 and/or from general knowledge of such obstacles 52, 72 as are typically to be expected on construction sites that the obstacles 52, 72 do not reach below a specific height H1. The level of the height Hl may be for example at least 30 cm below the ceiling, at least 80 cm below the ceiling, or at least 1 m below the ceiling.

In order to bypass the obstacles 52, 72 that are present on the construction site 58 and to move the end effector 14 to the working positions 50 and 64 without a collision, in the case of this exemplary embodiment the following movement scheme 74 is used:

First, the end effector 14 is moved in a direction perpendicular to the ceiling 62, that is to say in this case vertically or at least in a substantially vertical direction, away from the starting position 48, in the present case that is to say downward.

The end effector 14 does not reach as far as the height H1. In particular, it reaches a horizontal plane at the level of a height H2. In order in this way to arrive at the working position 50, in the representation according to FIG. 6 the end effector 14 is moved to the right as far as a position P1. At the position P1, it is below the working position 50 to be reached, in a perpendicular line. Then, the end effector 14 is moved perpendicularly upward from the position P1, in order to approach the working position 50, until it, in particular its tool 26 (FIG. 1), reaches it. Altogether, the end effector 14 has consequently been moved along a U-shaped movement scheme.

For example after completing a construction task to be carried out at the working position 50, the end effector 14 can be moved to the working position 64.

This can be analogously performed likewise by means of a U-shaped movement scheme. In particular, the end effector 14 may first be moved back to the position P1, so that it is once again below the height H1. Then, the end effector 14 may be moved to the left, until it comes to lie at a position P2 perpendicularly below the working position 64. Subsequently, it may be moved perpendicularly or at least substantially perpendicularly upward, and in this way the working position 62 approached, until it finally reaches it.

If the working positions 50 and/or 64 are close to the respective obstacles 52 and/or 72, before the upward movement from the respective position Pl or P2, in an analogous way as described in conjunction with FIGS. 4 and 5, the construction robot 10, its manipulator 12 and/or the end effector 14 may be additionally moved in order to align the end effector 14 suitably for reaching the working positions 50 and 64.

In this way, complex calculations of movement paths can be eliminated or at least substantially reduced.

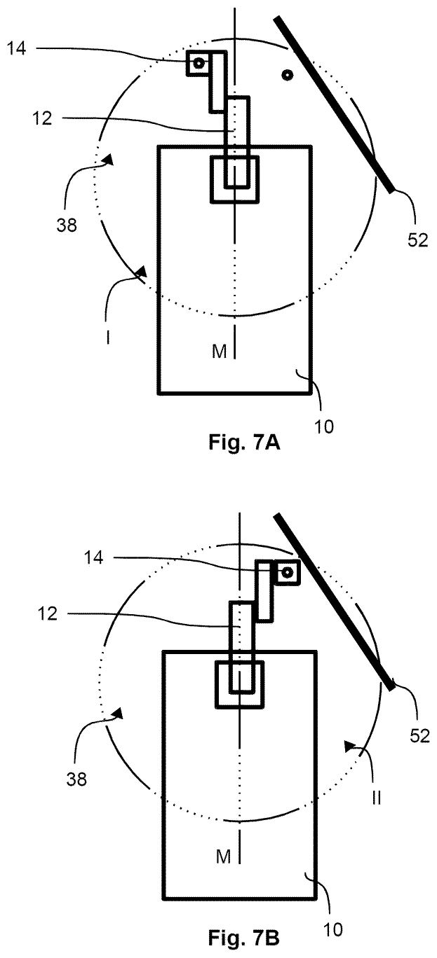

FIGS. 7A and 7B show schematic views from above of the construction robot 10 in a starting position before and an end position after a side-changing movement.

Before the side-changing movement (FIG. 7A), the end effector 14 is in a first hemisphere I of the working area 38—circular here for the sake of simplicity and by way of example—of the manipulator 12.

After the side-changing movement (FIG. 7B), the end effector 14 is in a second hemisphere II of the working area 38.

It can be seen by comparing the views from above according to FIG. 7A and FIG. 7B that, by the side-changing movement, the end effector 14 gets into a substantially mirror-inverted position relative to the manipulator 12 and/or relative to a central plane M of the construction robot 10. This allows the end effector 18 also to get to working positions at the edge of the working area 38 in the respective hemisphere I or II and to a working position 50 which is close to an obstacle 52 in one hemisphere, here for example the hemisphere II, and would not otherwise be reachable, or only with relatively great effort, for example by moving the entire construction robot 10 including its mobile platform 16 (FIG. 1) on the construction site concerned.

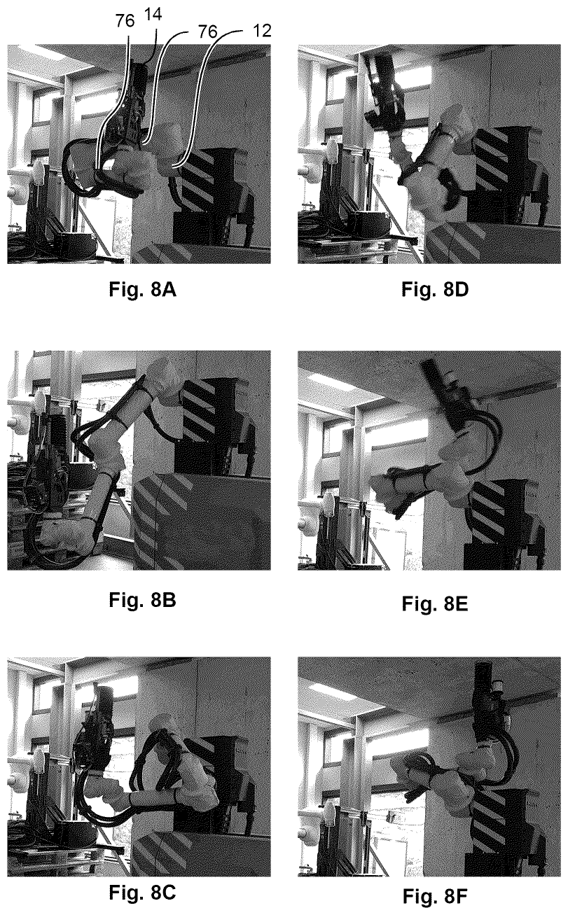

A movement scheme for such a side-changing movement, which makes a side change possible within a comparatively small volume, is represented in FIG. 8A to 8F.

FIG. 8A to 8F show in this respect the sequence of the side-changing movement in the form of photographic representations of individual phases of the movement scheme. For reasons of overall clarity, reference signs have in this case only been entered in FIG. 8A.

Starting for example from a rest position according to FIG. 8A, the manipulator 12 is first extended laterally downward (FIG. 8B) and subsequently pivoted together, then with an opposite alignment of two parts 76, 78 of the manipulator 12 in comparison with FIGS. 8A and 8B (FIGS. 8C, 8D, 8E). In this case, the end effector 14 comes close to its starting position, but then with a substantially mirror-inverted position of the parts 76, 78 in relation to one another in comparison with the starting position according to FIG. 8A. Finally, the manipulator 12 and/or the end effector 14 are rotated, until the end effector 14 gets into a desired end position, in particular as depicted in FIG. 8F.

The initial downward movement makes it possible here to save volume required for the side-changing movement as compared for example with a substantially horizontal movement. Consequently, this side-changing movement can be realized even when there are confined space conditions.

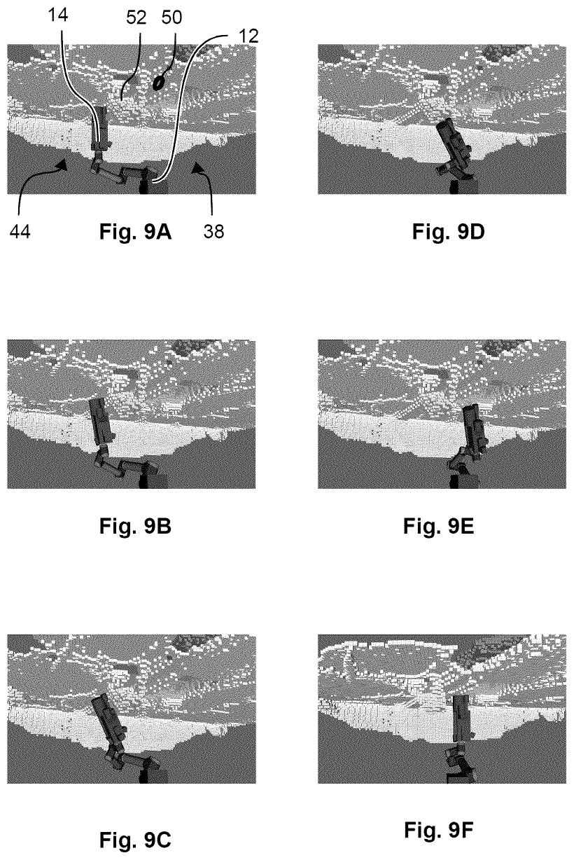

FIG. 9A to 9F show an alternative for the bypassing of an obstacle. It is conceivable to use this alternative on its own and/or in combination with another alternative, in particular by using a movement scheme, for example as described with reference to FIG. 6.

FIG. 9A bis 9F show in this respect the sequence of a movement of the manipulator 12 and the end effector 14 in the form of schematic representations of individual phases of the movement in conjunction with a point cloud of a working area 38.

Here too, for reasons of overall clarity, reference signs have only been entered in FIG. 9A.

By way of example, in the case of this exemplary embodiment it is assumed that the working area 38 has been optically scanned in advance by means of the 3D camera 34 (FIG. 1), in order to obtain an overall recording 44 and to detect an obstacle 52. Here too, it would be conceivable alternatively or additionally to analyze BIM data.

FIG. 9A to 9F show successive phases of a movement sequence, given by way of example, of the manipulator 12 together with the end effector 14, by which altogether the obstacle 52 is bypassed.

In the case of this alternative, the controller 18 (FIG. 1) calculates in advance a movement path from the starting position according to FIG. 9A up to an end position according to FIG. 9F by means of a dynamic search of a collision-free movement path.

As a result of the dynamic search, from the starting position (FIG. 9A) first the end effector 14 is tilted away according to the precalculated movement path (FIGS. 9B, 9C), in order to be able to bypass the obstacle 52 as closely as possible. The tilting of the end effector makes it possible to reduce the required distance over which the manipulator 12 must travel in order to be able to move the end effector 14 past the obstacle 52 by passing under it (FIG. 9D).

Subsequently, the end effector 14 is righted (FIG. 9E) and moved vertically upward, until it reaches the desired end position (FIG. 9F) and in particular a working position 50.

It is conceivable that, during this movement, the 3D camera 34 makes additional recordings of the working area 38.

In the case of one embodiment, the dynamic search of a collision-free movement path is performed in the form of a hybrid process.

The hybrid process may combine approaching in a straight line with at least one movement scheme. The hybrid process may for example take the following form:

The manipulator 12 and the end effector 14 are first modeled as a dynamic chain.

To search for a collision-free movement path, starting from a current position and location of the manipulator 12 and the end effector 14 in each case, it is attempted step by step to find a collision-free linear path to the working position 50, that is to say the position to be reached. If appropriate, the movement path is lowered and/or a horizontal movement is performed in order to get past the obstacle 52 by passing under it, and thus find a linear path.

On the basis of sets of test criteria, it is tested whether the manipulator 12 and/or the end effector 14 is in a “difficult” standard situation.

An example of such a “difficult” standard situation is for example the previously described case that the working position 50 to be reached is within a specific maximum distance from the obstacle 52. A further example concerns the case described in conjunction with FIGS. 7A, 7B and 8A to 8F that the end effector 14 is in one hemisphere, but the working position 50 requires a change to the other hemisphere.

If such a “difficult” standard situation is identified, an associated movement scheme, for example in the last-mentioned example the movement scheme for a side-changing movement, is selected and realized.

For this purpose, multiple sets of test criteria and associated movement schemes are stored in the program code PC (FIG. 1) of the controller 18 (FIG. 1). It is also conceivable that a U-shaped movement scheme and an associated set of test criteria suitable for this are also stored.

It is conceivable to select from multiple possible movement paths, which can in particular be found by this hybrid process, a movement path that satisfies the additional constraints. Such a constraint may be for example a small, in particular limited, number of changes of the hemisphere over the entire movement path. Such constraints allow travel paths to be additionally minimized.

It is also conceivable also to integrate the mobile platform 16 (FIG. 1) with its additional degrees of freedom into the modeling of the dynamic chain. This makes it possible to increase the size of the working area 38 that can be used by the construction robot 10 (FIG. 9A).

This hybrid process makes comparatively stable solutions with low traveling times possible. The hybrid process also makes it possible to find movement paths for a wide variety of working positions, and in this way to be able to reach the working positions.

Alternatively or additionally, it is also conceivable to use for example a Monte Carlo-based random tree process for the dynamic search.

### LIST OF REFERENCE SIGNS

10 Construction robot
12 Manipulator
14 End effector
16 Platform
18 Controller
20 Lifting device
22 Arm
24 Power tool
26 Tool
30 Computer
32 Paint spraying device
33 Prism
34 3D camera
36 Recording
38 Working area
40 Cable duct
42 Object
44 Overall recording
46 Unevenness
48 Starting position
50 Working position
52 Obstacle
56 BIM data
58 Construction site
60 Wall
62 Ceiling
64 Working position
66 Step
68 Installation element
70 Installation element
72 Obstacle
74 Movement scheme
76 Part
78 Part
H1 Height
H2 Height
I Hemisphere
II Hemisphere
M Central plane
P1 Position
P2 Position
PC Program code
I1 Diameter
I2 Diameter

1. A method for controlling a construction robot which has a manipulator and wherein the manipulator has an end effector, wherein the end effector (14) is moved from a starting position to a working position the method comprising identifying
an obstacle, and
bypassing the identified obstacle.

2. The method as claimed in claim 1, comprising realizing at least one movement scheme.

3. The method as claimed in claim 2, wherein the at least one movement scheme corresponds to a U-shaped or substantially U-shaped movement.

4. The method as claimed in claim 2, wherein the at least one movement scheme comprises a side-changing movement.

5. The method as claimed in claim 1, wherein the end effector has a tool, the method including moving the tool the working position in a working direction and wherein the end effector is aligned in such a way that the tool is moved by a distance (d) of less than half a length of a longest diameter (I1) in a plane perpendicular to the working direction of the end effector.

6. The method as claimed in claim 5, wherein while moving to the working position, the manipulator is moved past the obstacle.

7. The method as claimed in claim 1, including optically scanning a working area a range meter.

8. The method as claimed in claim 1, including moving the range meter during the optical scanning.

9. The method as claimed in claim 1, including moving the end effector to at least two working positions one after the other in one hemisphere (I, II) of a working area of the construction robot.

10. The method as claimed in claim 1, wherein on the basis of one working position as a starting position, a subsequent working position is selected such that the subsequent working position can be reached from the starting position without bypassing the obstacle.

11. A construction robot comprising a manipulator with an end effector and a controller, wherein the controller is set up to control the construction robot by the method of claim 1.

12. A construction robot comprising a manipulator with an end effector and a controller, wherein the controller is set up to control the manipulator and/or the end effector in a U-shaped movement, a substantially U-shaped movement and/or a side-changing movement.

13. The method of claim 7, wherein the range meter is a 3D camera.

14. The method of claim 9, including moving the end effector to at least two working positions of the working area of the manipulator of the construction robot.

15. The construction robot of claim 12, wherein the controller is set up to control the manipulator and/or the end effector in the U-shaped movement, the substantially U-shaped movement and/or a side-changing movement, in which the end effector changes from one hemisphere (I, II) of a working area of the manipulator to another hemisphere (I, II) of the working area.

16. The method of claim 2, wherein the end effector has a tool, the method including moving the tool the working position in a working direction and wherein the end effector is aligned in such a way that the tool is moved by a distance (d) of less than half a length of a longest diameter (I1) in a plane perpendicular to the working direction of the end effector.

17. The method of claim 16, wherein while moving to the working position, the manipulator is moved past the obstacle.

18. The method of claim 2, including optically scanning a working area a range meter.

19. The method of claim 18, including moving the range meter during the optical scanning.

20. The method of claim 2, including the end effector moving the to at least two working positions one after the other in one hemisphere (I, II) of a working area of the construction robot.
